(19) United States
(12) Patent Application Publication
(10) Pub. No.: US 2017/0356991 A1
(43) Pub. Date: Dec. 14, 2017

(54) RADAR DEVICE AND DETECTION METHOD

(71) Applicant: Panasonic Intellectual Property Management Co., Ltd., Osaka (JP)

(72) Inventors: NAOYA YOSOKU, Shizuoka (JP); HIROFUMI NISHIMURA, Kanagawa (JP)

(21) Appl. No.: 15/612,855

(22) Filed: Jun. 2, 2017

(30) Foreign Application Priority Data
Jun. 13, 2016 (JP) 2016-117102

(51) Int. Cl. G01S 13/56; G01S 13/89; G01S 13/60; G01S 13/93

(52) U.S. Cl. CPC G01S 13/56; G01S 13/931; G01S 13/89; G01S 13/60

(57) ABSTRACT

There is provided a radar device including: a transmitter including a first antenna which, in operation, transmits a radar signal; a receiver including a second antenna which, in operation, receives an echo signal that is the radar signal reflected from an object; a stationary object boundary detector which, in operation, detects a boundary of a first region in which a stationary object exists by using the echo signal; and a stationary object boundary variations detector which, in operation, detects a second region in which temporal changes are observed in the boundary of the first region and detects a third region that is the region moving in a cross-range direction, as a first moving object.

### BACKGROUND

### 1. Technical Field

The present disclosure relates to a radar device and a detection method that detect a moving object.

### 2. Description of the Related Art

In the past, various techniques about a radar device have been disclosed. For example, in Japanese Patent No. 4643475, the technique is disclosed by which, when a plurality of objects to be detected (hereinafter, targets) exist in the same range in the same width of beam radiated by a radar device, a difference in the Doppler frequency based on a difference in the moving velocity between the targets is extracted by a Doppler filter and the targets are separately detected.

### SUMMARY

One non-limiting and exemplary embodiment facilitates providing a radar device and a detection method that can detect a target separately from a peripheral stationary object.

In one general aspect, the techniques disclosed here feature a radar device including: a transmitter including a first antenna which, in operation, transmits a radar signal; a receiver including a second antenna which, in operation, receives an echo signal that is the radar signal reflected from an object; a stationary object boundary detector which, in operation, detects a boundary of a first region in which a stationary object exists by using the echo signal; and a stationary object boundary variations detector which, in operation, detects a second region in which temporal changes are observed in the boundary of the first region and detects a third region that is the region moving in a cross-range direction, as a first moving object.

It should be noted that general or specific embodiments may be implemented as a system, a method, an integrated circuit, a computer program, a storage medium, or any selective combination thereof.

According to one aspect of the present disclosure, it is possible to detect a target separately from a peripheral stationary object.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 depicts a detection method of detecting a target by using a Doppler frequency;

FIG. 2 depicts an example of the configuration of a radar device according to a first embodiment of the present disclosure;

FIG. 3A depicts an example of a range profile;

FIG. 3B depicts an example of the range profiles accumulated in chronological order;

FIG. 3C depicts an example of a [range, Doppler] map;

FIG. 3D depicts an example of an [azimuth, range, Doppler] map;

FIG. 4A depicts an example of the positional relationship of a target at rest and a vehicle;

FIG. 4B depicts a first example of a stationary object Doppler region;

FIG. 4C depicts a second example of the stationary object Doppler region;

FIG. 5A depicts an example of a stationary object boundary which is set with reference to the radar device;

FIG. 5B depicts the example of the stationary object boundary which is set with reference to the radar device;

FIG. 6 depicts an example of the configuration of a stationary object boundary detecting unit and a stationary object boundary variations detecting unit according to the first embodiment of the present disclosure;

FIG. 7A depicts an example of a detection method of detecting the stationary object boundary in the first embodiment of the present disclosure;

FIG. 7B depicts the example of the detection method of detecting the stationary object boundary in the first embodiment of the present disclosure;

FIG. 8A depicts coordinate conversion processing in a coordinate converting unit;

FIG. 8B depicts the coordinate conversion processing in the coordinate converting unit;

FIG. 9 depicts an example of smoothing processing in a boundary smoothing unit;

FIG. 10 depicts an example of a convex portion which is detected by a convex portion azimuth boundary detecting unit;

FIG. 11 depicts an example of detection processing in the convex portion azimuth boundary detecting unit;

FIG. 12A depicts an example of a convex portion azimuth table;

FIG. 12B depicts an example of a stationary object boundary observed by the radar device in the past;

FIG. 12C depicts an example of a stationary object boundary observed by the radar device in the present;

FIG. 13 depicts an example of the configuration of a stationary object boundary detecting unit according to a second embodiment of the present disclosure;

FIG. 14A depicts an example of a detection method of detecting a stationary object boundary in the second embodiment of the present disclosure;

FIG. 14B depicts the example of the detection method of detecting the stationary object boundary in the second embodiment of the present disclosure;

FIG. 15 depicts an example of the configuration of a radar device according to a third embodiment of the present disclosure;

FIG. 16A depicts combining processing in a detected results combining unit; and

FIG. 16B depicts the combining processing in the detected results combining unit.

### DETAILED DESCRIPTION

First, the underlying knowledge forming the basis of the present disclosure will be described. The present disclosure relates to a radar device and a detection method that detect a target moving in a cross-range direction (a direction which is substantially perpendicular to a straight line connecting the target and the radar device).

In recent years, the development of the technique related to support for vehicle's safe driving has been carried out. A technique of accurately recognizing the circumstances surrounding a vehicle is vital to support vehicle's safe driving. As the technique of recognizing the circumstances surrounding the vehicle, mounting of a radar device on the vehicle is possible.

Since the vehicle moves, the circumstances surrounding the vehicle change with time. Therefore, the amount of computation necessary for the radar device mounted on the vehicle to recognize the surrounding circumstances tends to increase. On the other hand, since the radar device has limited hardware resources, simplification of computation is required to allow the radar device to recognize the surrounding circumstances by using the limited resources.

To recognize the surrounding circumstances with simple computation by using the radar device, for example, a possible method includes: radar device receiving reflected waves from peripheral objects including a target and a peripheral stationary object; and separately detecting the moving target and the peripheral stationary object by using the Doppler frequency extracted from the received reflected waves.

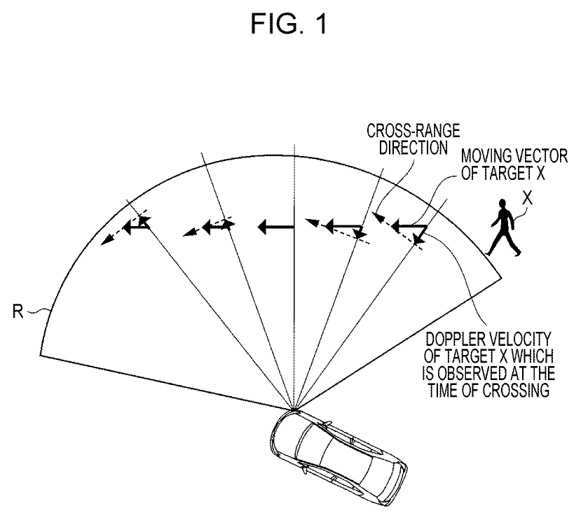

FIG. 1 is a diagram depicting a detection method of detecting a target by using a Doppler frequency. A fan-shaped range R depicted in FIG. 1 is an example of a sensing range of a radar device which is mounted on a vehicle. Moreover, in FIG. 1, a target X (for example, a pedestrian) moving in the range R is depicted.

Of the moving velocity (moving vector) of the target X, the Doppler velocity (the value obtained by converting a Doppler frequency into a velocity) that can be observed by the radar device is a velocity component in a direction of a straight line connecting the target X and the radar device (hereinafter referred to as a range direction). Under circumstances where the velocity component in the range direction is large (for example, circumstances where the target X moves near the ends of the range R in FIG. 1), the Doppler velocity of the target X is different from the Doppler velocity of a peripheral stationary object. Therefore, the radar device can detect the target X separately from the peripheral stationary object by using the Doppler velocity.

However, if the moving velocity of the target X is equal to the moving velocity of the vehicle or the like on which the radar device is mounted, that is, if the relative velocity of the target X and the radar device is close to zero, it is difficult to detect the target X separately from the peripheral stationary object by using the Doppler velocity.

Moreover, under circumstances where the target X moves in a cross-range direction which is substantially perpendicular to the range direction and the velocity component in the range direction is small (for example, circumstances where the target X moves near the center of the range R in FIG. 1), the Doppler velocity of the target X gets closer to zero and the difference between the Doppler velocity of the target X and the Doppler velocity of the peripheral stationary object is reduced. This makes it difficult for the radar device to detect the target X separately from the peripheral stationary object by using the Doppler velocity.

Thus, what will be described below is how to detect a target separately from a peripheral stationary object even when a difference between the Doppler velocity of the target and the Doppler velocity of the peripheral stationary object is small.

Hereinafter, an embodiment of the present disclosure will be described with reference to the drawings. It is to be noted that the embodiment which will be described below is an example and the present disclosure is not limited by the following embodiment.

### First Embodiment

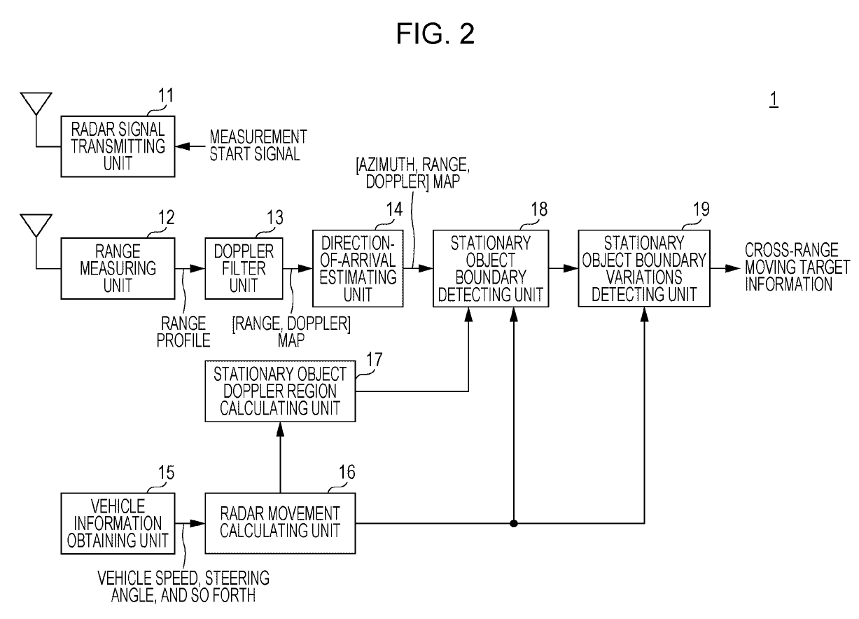

FIG. 2 is a block diagram depicting an example of the configuration of a radar device 1 according to a first embodiment. The radar device 1 is mounted on a moving body such as a vehicle and detects a peripheral object. The radar device 1 includes a radar signal transmitting unit 11, a range measuring unit 12, a Doppler filter unit 13, a direction-of-arrival estimating unit 14, a vehicle information obtaining unit 15, a radar movement calculating unit 16, a stationary object Doppler region calculating unit 17, a stationary object boundary detecting unit 18, and a stationary object boundary variations detecting unit 19. Hereinafter, each component element will be described with reference to the drawing.

When a measurement start signal is input to the radar signal transmitting unit 11, the radar signal transmitting unit 11 transmits a radar signal for performing sensing. The radar signal transmitting unit 11 transmits the radar signal via one or more transmitting antennas.

The range measuring unit 12 receives, via one or more receiving antennas, an echo signal (reflected wave) that is the radar signal reflected from the target and performs received signal processing. Then, the range measuring unit 12 calculates a range profile indicating the range (distance) to the target by using the delay time between the transmission of the radar signal and the reception of the echo signal.

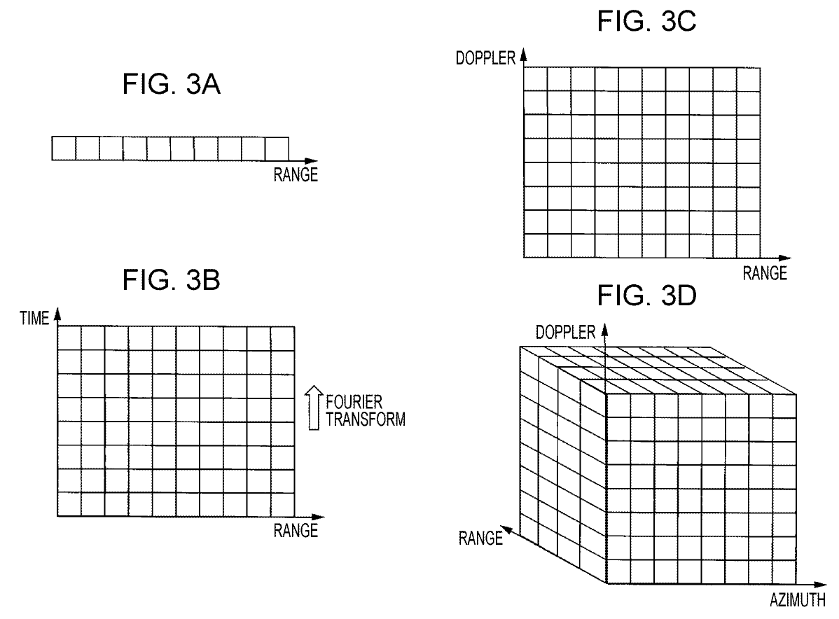

FIG. 3A is a diagram depicting an example of the range profile. The horizontal axis of FIG. 3A represents the range. The range profile indicates the reflection intensity of the echo signal subjected to received signal processing in each range with an IQ component (that is, a complex number). That is, a grid of each range in FIG. 3A contains the value of a complex number. The range measuring unit 12 calculates the range profile depicted in FIG. 3A and outputs the range profile to the Doppler filter unit 13.

The Doppler filter unit 13 accumulates the range profiles which are obtained from the range measuring unit 12 in chronological order. The Doppler filter unit 13 performs Fourier transform on the profile data in each range bin (time series of the same range) of the accumulated range profiles, analyzes the Doppler frequency, and generates a [range, Doppler] map.

FIG. 3B is a diagram depicting an example of the range profiles accumulated in chronological order. The horizontal axis of FIG. 3B represents the range and the vertical axis represents time. FIG. 3C is a diagram depicting an example of the [range, Doppler] map. The horizontal axis of FIG. 3C represents the range and the vertical axis represents the Doppler velocity.

The Doppler filter unit 13 performs Fourier transform on the profile data in each range bin of the range profiles accumulated in chronological order, which are depicted in FIG. 3B, and calculates the Doppler frequency of each range. Then, the Doppler filter unit 13 converts the calculated Doppler frequency into the Doppler velocity. Specifically, a Doppler velocity vd is calculated by using Equation (1) below, where λ represents the wavelength of the radar signal, and fd represents the Doppler frequency.

vd=−λ×fd/2 (1)

In a direction in which the target relatively moves away from the radar device 1, the Doppler velocity vd is positive. In a direction in which the target relatively gets closer to the radar device 1, the Doppler velocity vd is negative.

The Doppler filter unit 13 converts the Doppler frequency into the Doppler velocity and generates the [range, Doppler] map depicted in FIG. 3C. The [range, Doppler] map is a map indicating the spatial spectrum of the Doppler velocity in each range bin, with the horizontal axis representing the range and the vertical axis representing the Doppler velocity. The Doppler filter unit 13 outputs the [range, Doppler] map to the direction-of-arrival estimating unit 14.

The range measuring unit 12 and the Doppler filter unit 13 perform processing for each of the received signals which are obtained from the one or more receiving antennas and output a [range, Doppler] map for each receiving antenna.

The direction-of-arrival estimating unit 14 estimates the direction of arrival of the received echo signal by a predetermined direction-of-arrival estimating algorithm by using in-phase quadrature (IQ) data in each [range, Doppler] bin of the [range, Doppler] map for each receiving antenna, the [range, Doppler] map which is obtained from the Doppler filter unit 13. Incidentally, as the direction-of-arrival estimating algorithm, for example, a beamformer technique, Capon, or MUSIC is used. Then, the direction-of-arrival estimating unit 14 generates an [azimuth, range, Doppler] map. In the above-described algorithm, the direction of arrival is estimated by using, for example, a phase difference between IQ data in the [range, Doppler] bins for each receiving antenna.

FIG. 3D is a diagram depicting an example of the [azimuth, range, Doppler] map. Three axes in FIG. 3D represent the azimuth, the range, and the Doppler velocity. The direction-of-arrival estimating unit 14 estimates the direction-of-arrival (that is, the azimuth direction in the radar device 1) from the data in each [range, Doppler] bin of the [range, Doppler] map depicted in FIG. 3C and generates the [azimuth, range, Doppler] map depicted in FIG. 3D. That is, the [azimuth, range, Doppler] map is a map indicating the power (spatial spectrum) in each [azimuth, range, Doppler] bin. The direction-of-arrival estimating unit 14 outputs the [azimuth, range, Doppler] map to the stationary object boundary detecting unit 18.

The range measuring unit 12, the Doppler filter unit 13, and the direction-of-arrival estimating unit 14 function as a received signal analyzing unit that analyzes the received echo signal and generates data on the spatial spectrum indicating the reflection intensity in each azimuth, in each range, and at each Doppler velocity.

The vehicle information obtaining unit 15 obtains vehicle information about the movement of the vehicle, such as a vehicle speed, a steering angle, and a turning speed, from various unillustrated sensors mounted on the vehicle and outputs the vehicle information to the radar movement calculating unit 16.

The radar movement calculating unit 16 calculates a radar velocity vector indicating the moving velocity of the radar device 1 by using the vehicle information which is obtained from the vehicle information obtaining unit 15 and the known information on the installation position of the radar device 1. The radar movement calculating unit 16 outputs the calculated radar velocity vector to the stationary object Doppler region calculating unit 17.

The stationary object Doppler region calculating unit 17 calculates a velocity component in the range direction from the radar velocity vector obtained from the radar movement calculating unit 16.

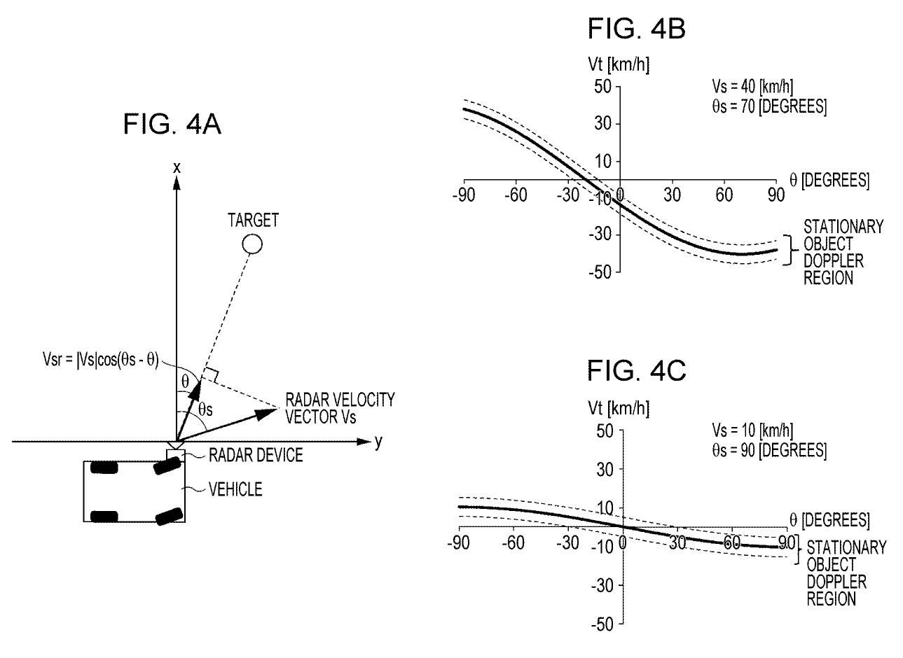

Stationary object Doppler region calculation processing in the stationary object Doppler region calculating unit 17 will be specifically described with reference to FIGS. 4A to 4C. FIG. 4A is a diagram depicting an example of the positional relationship of a target at rest and a vehicle. FIG. 4B is a diagram depicting a first example of a stationary object Doppler region. FIG. 4C is a diagram depicting a second example of the stationary object. Doppler region.

In FIG. 4A, the vehicle, the radar device 1 mounted on the vehicle, and the target in the sensing range of the radar device 1 are depicted. The x axis depicted in FIG. 4A represents a front direction of the radar device 1 and the y axis is an axis perpendicular to the x axis. The x-y plane depicted in FIG. 4A is a plane which is substantially parallel to a road surface on which the vehicle is running. Moreover, a radar velocity vector Vs calculated by the radar movement calculating unit 16 and a velocity component Vsr in the range direction with respect to the target are depicted.

Incidentally, the target in FIG. 4A is an object at stationary state.

The velocity component Vsr is calculated by Equation (2) below, where θs represents the angle which the velocity vector Vs forms with the x axis, θ represents the angle which a straight line connecting the radar device 1 and the target (that is, the range direction with respect to the target) forms with the x axis, and a direction in which the target moves away from the radar device 1 is assumed to be positive.

Vsr=|Vs|×cos(θs−θ) (2)

Then, the magnitude of a velocity component Vt corresponding to the Doppler velocity of the target is calculated by Equation (3) below.

Vt=−Vsr=−|Vs|×cos(θs−θ) (3)

FIG. 4B is a diagram obtained by plotting the velocity component Vt in Equation (3), when |Vs|=40 [km/h] and θs=70 [degrees]. The horizontal axis in FIG. 4B represents θ in Equation (3), that is, the azimuth in which the target exists, and the vertical axis represents the velocity component Vt, where a direction in which the target moves away from the radar device 1 is assumed to be positive.

The stationary object Doppler region calculating unit 17 calculates the velocity component Vt for each θ based on the velocity vector Vs and Equation (3). Then, the stationary object Doppler region calculating unit 17 calculates, as a stationary object Doppler region, a region (a region sandwiched between dotted lines in FIG. 4B) provided with a predetermined margin with consideration given to an error contained in the calculated velocity component Vt. For example, in FIG. 4B, a stationary object Doppler region with an upward margin of 5 [km/h] and a downward margin of −5 [km/h] for the velocity component Vt is depicted. It is to be noted that the upward margin and the downward margin can be set as appropriate in accordance with the velocity vector, for example.

Since the radar device 1 is mounted on the vehicle, the radar velocity vector changes with time. For this reason, the stationary object Doppler region calculated by the stationary object Doppler region calculating unit 17 also changes with time in response to changes in the radar velocity vector. In FIG. 4C, an example of changes in the stationary object Doppler region is depicted.

FIG. 4C is a diagram obtained by plotting the velocity component Vt in Equation (3), when |Vs|=10 [km/h] and θs=90 [degrees]. The horizontal axis in FIG. 40 represents θ in Equation (3), that is, the azimuth in which the target exists, and the vertical axis represents the velocity component Vt when the direction in which the target exists is assumed to be positive. Moreover, in FIG. 40, the stationary object Doppler region with the upward margin of 5 [km/h] and the downward margin of −5 [km/h] is depicted.

As depicted in FIGS. 4B and 40, the stationary object Doppler region changes in response to the magnitude (|Ns|) of the radar velocity vector Vs or the angle (θs). The stationary object Doppler region calculating unit 17 outputs the calculated stationary object Doppler region to the stationary object boundary detecting unit 18.

The stationary object boundary detecting unit 18 detects the boundary of a region in which the stationary object exists (hereinafter referred to as a stationary object boundary) by using the echo signal. Specifically, the stationary object boundary detecting unit 18 detects a stationary object boundary which is set with reference to the radar device 1 by using the [azimuth, range, Doppler] map which is obtained from the direction-of-arrival estimating unit 14 and the stationary object Doppler region which is obtained from the stationary object Doppler region calculating unit 17.

The stationary object boundary is a line connecting, of the points at which reflection from an object which is regarded as a stationary object was detected in the sensing range of the radar device 1, points closest to the radar device 1. Determination as to whether reflection is reflection from an object which is regarded as a stationary object or not is made based on the Doppler velocity. For example, a reflection point whose Doppler velocity is in the stationary object Doppler region depicted in FIG. 4B or 4C may correspond to a stationary object.

The stationary object boundary is depicted as a line connecting a plurality of coordinates on an [azimuth, range] plane, for example.

Then, the stationary object boundary detecting unit 18 converts the past stationary object boundary into the present coordinate system by using the radar velocity vector in order to suppress variations in the stationary object boundary caused by an error and performs smoothing processing. The stationary object boundary detecting unit 18 outputs the detected stationary object boundary to the stationary object boundary variations detecting unit 19.

The stationary object boundary variations detecting unit 19 detects temporal variations in the stationary object boundary by using the stationary object boundary which is obtained from the stationary object boundary detecting unit 18.

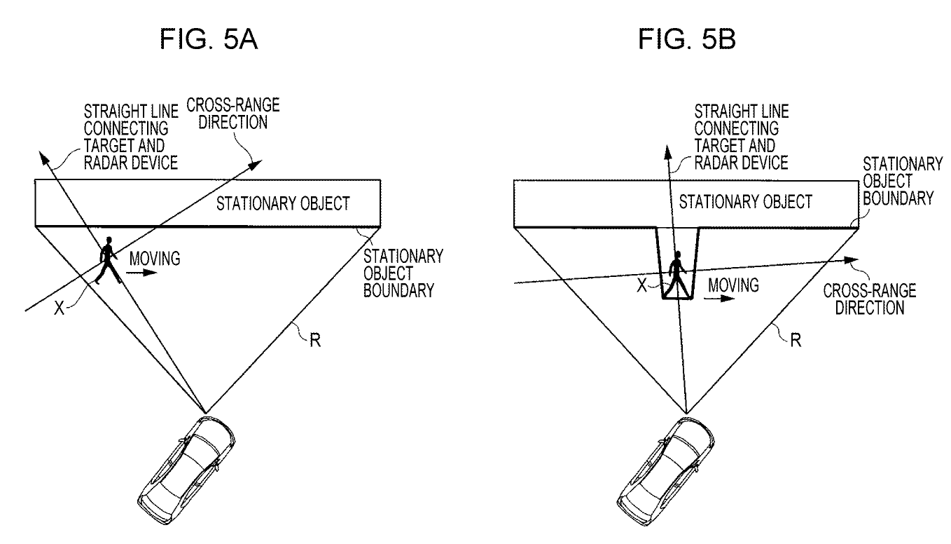

Although the stationary object boundary detecting unit 18 and the stationary object boundary variations detecting unit 19 will be described later, the outline thereof will be described below with reference to FIGS. 5A and 5B.

FIGS. 5A and 5B are diagrams depicting an example of the stationary object boundary which is set with reference to the radar device 1. FIGS. 5A and 5B depict how the target X moving in the sensing range R of the radar device 1 moves in front of a stationary object.

In FIG. 5A, the target X moves in a direction different from the cross-range direction, and the radar device 1 can observe a Doppler velocity component in the range direction (the direction of a straight line connecting the target and the radar device) which is set with reference to the radar device 1. As a result, the Doppler velocity of the target X which is observed by the radar device 1 is a value outside the stationary object Doppler region. Therefore, the target X is separated from the stationary object boundary.

On the other hand, in the case of FIG. 5B, since the target X moves in a direction close to the cross-range direction, a value equal to the Doppler velocity of the stationary object is observed as the value of the Doppler velocity of the target X. That is, the Doppler velocity of the target X is a value in the stationary object Doppler region. Therefore, the target X is regarded as the stationary object, and the target X is not separated from the stationary object boundary.

In any position in the sensing range R of the radar device 1, as the value of the Doppler velocity of the target X moving in a direction close to the cross-range direction, a value equal to the Doppler velocity of the stationary object is observed. That is, when the target X is located in the position of FIG. 5A and moves in a direction close to the cross-range direction, a value equal to the Doppler velocity of the stationary object is observed as the value of the Doppler velocity of the target X.

However, since the target X moves, even when the target X is not separated from the stationary object boundary, the stationary object boundary varies with time with the movement of the target X. In such a case, the target X moving in the cross-range direction, that is, moving in the stationary object Doppler region may appear as a convex portion in the stationary object boundary as depicted in FIG. 5B.

Therefore, in the first embodiment, the stationary object boundary detecting unit 18 detects the stationary object boundary depicted in FIGS. 5A and 5B and the stationary object boundary variations detecting unit 19 detects the target X moving in the cross-range direction, that is, moving in the stationary object Doppler region based on the temporal variations in the convex portion included in the stationary object boundary.

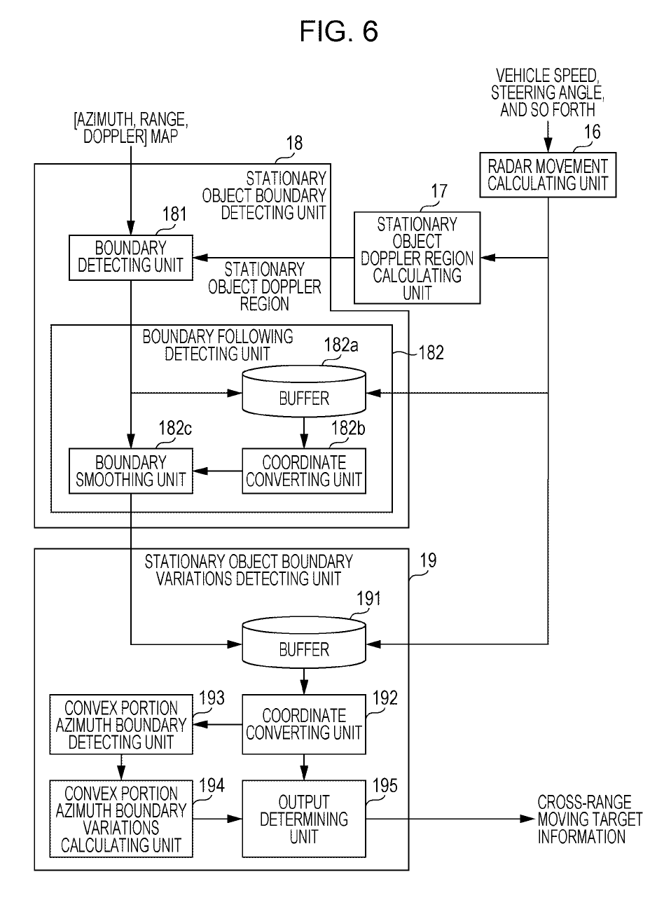

Next, the stationary object boundary detecting unit 18 and the stationary object boundary variations detecting unit 19 will be described with reference to FIG. 6.

FIG. 6 is a block diagram depicting an example of the configuration of the stationary object boundary detecting unit 18 and the stationary object boundary variations detecting unit 19 according to the first embodiment. Incidentally, for the sake of facilitating understanding, in FIG. 6, the radar movement calculating unit 16 and the stationary object Doppler region calculating unit 17 are also depicted.

The stationary object boundary detecting unit 18 includes a boundary detecting unit 181 and a boundary following detecting unit 182.

The boundary detecting unit 181 detects the present stationary object boundary which is set with reference to the radar device 1 by using the [azimuth, range, Doppler] map which is obtained from the direction-of-arrival estimating unit 14 and the stationary object Doppler region which is obtained from the stationary object Doppler region calculating unit 17.

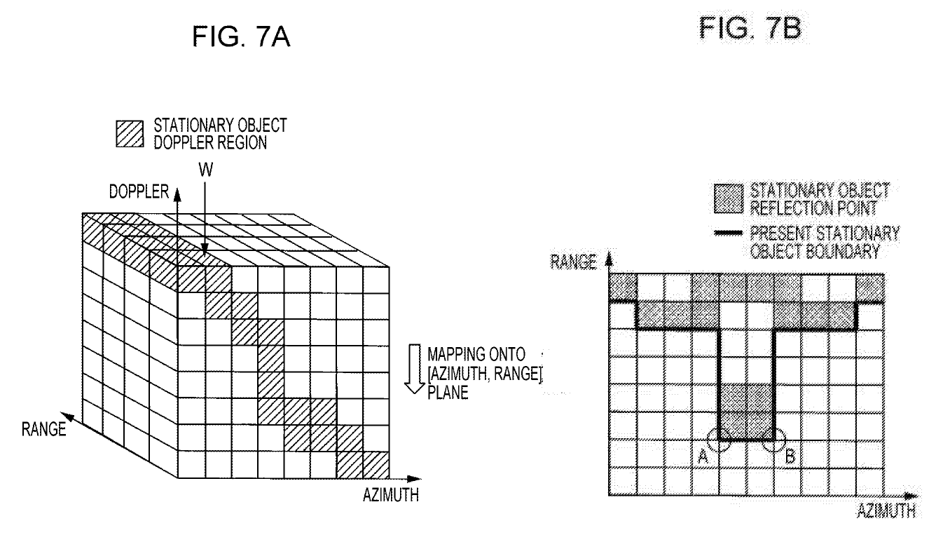

FIGS. 7A and 7B are diagrams depicting an example of a detection method of detecting the stationary object boundary in the first embodiment. As depicted in FIG. 7A, on the [azimuth, range, Doppler] map, the boundary detecting unit 181 maps data on a region corresponding to the stationary object Doppler region onto an [azimuth, range] plane defined by the azimuth axis and the range axis.

In so doing, when the boundary detecting unit 181 maps a plurality of pieces of data in one azimuth and one range (for example, mapping in a direction indicated by an arrow W in FIG. 7A), the boundary detecting unit 181 calculates one piece of data from the plurality of pieces of data by a method such as addition of spatial spectra, addition of power, or selection of a maximum value and maps the data onto the [azimuth, range] plane. Hereinafter, the data on the [azimuth, range] plane after mapping is referred to as an [azimuth, range] map.

FIG. 7B depicts the [azimuth, range] map. Since data on a region corresponding to the stationary object. Doppler region on the [azimuth, range, Doppler] map is mapped onto the [azimuth, range] plane, the coordinates of data greater than a predetermined threshold value of the data indicated on the [azimuth, range] map correspond to a point at which reflection from the stationary object was detected (hereinafter, a stationary object reflection point).

As depicted in FIG. 7B, the boundary detecting unit 181 detects the coordinates at which the range coordinates of the stationary object reflection point are minimized in each azimuth bin of the [azimuth, range] map as the present stationary object boundary.

When spatial spectrum power exceeding a predetermined threshold value does not exist because of, for example, the absence of a peripheral stationary object (for instance, a building), the boundary detecting unit 181 sets the range coordinates of the stationary object boundary at infinity.

Moreover, the boundary detecting unit 181 may divide the [azimuth, range] map into predetermined regions and, when the number of stationary object reflection points in the regions obtained by division is greater than or equal to a predetermined number, set the boundary of the regions obtained by division as the present stationary object boundary.

The boundary detecting unit 181 outputs the detected present stationary object boundary to the boundary following detecting unit 182.

The boundary following detecting unit 182 performs smoothing processing by using the present stationary object boundary and the past stationary object boundary. When one measurement time in the radar device 1 is assumed to be one frame and the present frame is assumed to be an Nth frame, the past stationary object boundary is the stationary object boundary from an N−Pth frame, which is a frame P frames (P is a predetermined number and an integer greater than or equal to 1) before the present frame, to an N−1 th frame. Specifically, the boundary following detecting unit 182 includes a buffer 182a, a coordinate converting unit 182b, and a boundary smoothing unit 182c.

In the buffer 182a, the present stationary object boundary which is obtained from the boundary detecting unit 181 and the present radar velocity vector which is obtained from the radar movement calculating unit 16 are stored in a state in which the present stationary object boundary and the present radar velocity vector are correlated with each other. In the buffer 182a, a plurality of stationary object boundaries and radar velocity vectors are stored.

The coordinate converting unit 182b reads the past stationary object boundary and the corresponding past radar velocity vector which are stored in the buffer 182a and converts the past stationary object boundary into the present coordinate system.

Since each frame time interval is a very short time period (about a few msec-interval), the radar moving velocity between the frames is supposed to be constant. That is, the radar moving vector indicating the movement of the radar device 1 between the frames is obtained by multiplying the radar velocity vector in each frame by the time of one frame. The radar moving vector from a certain point in time in the past to the present time is obtained by adding the radar moving vectors between the frames.

The coordinate converting unit 182b calculates the radar moving vector from the past radar velocity vector and shifts the past stationary object boundary in the opposite direction of the radar moving vector. That is, the coordinate converting unit 182b shifts the past stationary object boundary by an amount corresponding to a relative moving vector which is set with reference to the radar device 1 (relative moving vector).

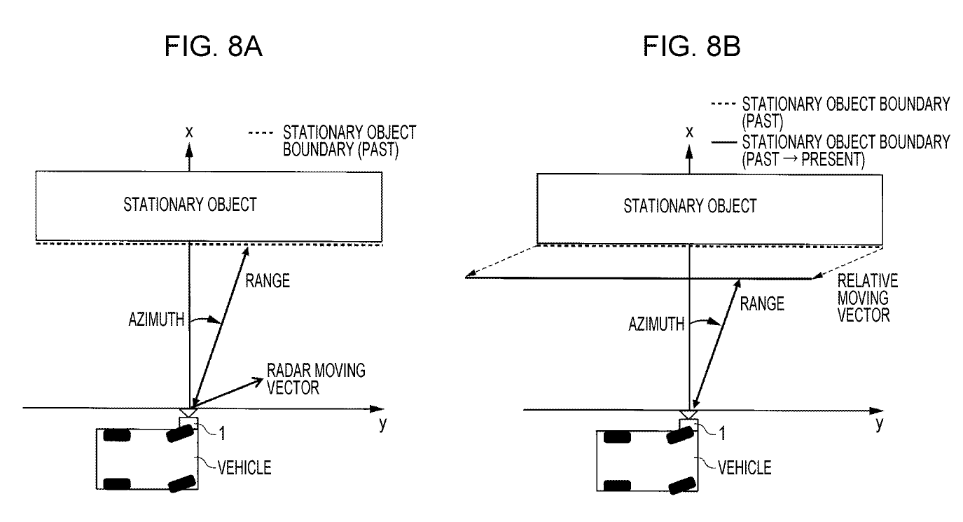

FIGS. 8A and 8B are diagrams depicting coordinate conversion processing in the coordinate converting unit 182b. In FIG. 8A, the past stationary object boundary and the radar moving vector are depicted. In FIG. 8B, the past stationary object boundary and the present stationary object boundary obtained by shifting the past stationary object boundary by an amount corresponding to the relative moving vector are depicted.

The coordinate converting unit 182b converts the past stationary object boundary indicated by the azimuth and the range into an x-y coordinate system whose origin is set at the position of the radar device 1. Then, the coordinate converting unit 182b shifts the converted stationary object boundary by an amount corresponding to the relative moving vector and obtains the present stationary object boundary depicted in FIG. 8B. The coordinate converting unit 182b converts the present stationary object boundary indicated by the x-y coordinate system into a coordinate system indicated by the azimuth and the range.

The coordinate converting unit 182b outputs the present stationary object boundary indicated by the azimuth and range to the boundary smoothing unit 182c.

The boundary smoothing unit 182c obtains the present stationary object boundary from the boundary detecting unit 181 and obtains the present stationary object boundary obtained by converting the past stationary object boundary from the coordinate converting unit 182b. Then, the boundary smoothing unit 182c performs smoothing on the two stationary object boundaries.

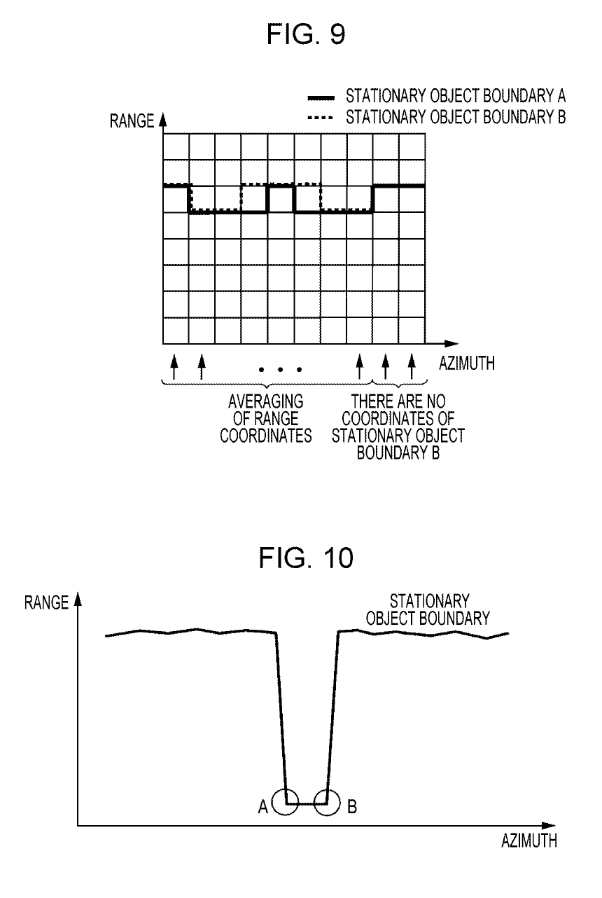

FIG. 9 is a diagram depicting an example of the smoothing processing in the boundary smoothing unit 182c. In FIG. 9, on the [azimuth, range] plane, a present stationary object boundary A obtained from the boundary detecting unit 181 and a present stationary object boundary B (that is, the present stationary object boundary obtained by converting the past stationary object boundary) obtained from the coordinate converting unit 182b are depicted.

As the smoothing processing, the boundary smoothing unit 182c performs averaging of the range coordinates of the stationary object boundary A and the range coordinates of the stationary object boundary B in each azimuth bin. In an azimuth bin in which the range coordinates of one of the stationary object boundaries do not exist, the boundary smoothing unit 182c performs averaging of the range coordinates which exist.

The boundary smoothing unit 182c outputs the present stationary object boundary obtained by the smoothing processing to the stationary object boundary variations detecting unit 19.

As depicted in FIG. 6, the stationary object boundary variations detecting unit 19 includes a buffer 191, a coordinate converting unit 192, a convex portion azimuth boundary detecting unit 193, a convex portion azimuth boundary variations calculating unit 194, and an output determining unit 195.

In the buffer 191, the present stationary object boundary which is obtained from the boundary smoothing unit 182c and the present radar velocity vector which is obtained from the radar movement calculating unit 16 are stored in a state in which the present stationary object boundary and the present radar velocity vector are correlated with each other. In the buffer 191, stationary object boundaries and radar velocity vectors of a plurality of frames are stored.

The coordinate converting unit 192 reads the past stationary object boundary and the corresponding past radar velocity vector which are stored in the buffer 191 and converts the past stationary object boundary into the present coordinate system. Since the coordinate conversion processing in the coordinate converting unit 192 is similar to the coordinate conversion processing in the coordinate converting unit 182b, the detailed explanations thereof will be omitted.

The coordinate converting unit 192 outputs the stationary object boundary obtained by conversion of the past stationary object boundary into the present coordinate system by the coordinate conversion processing and the present stationary object boundary to the convex portion azimuth boundary detecting unit 193.

The convex portion azimuth boundary detecting unit 193 detects the azimuth in which a convex portion appears in the range direction of the [azimuth, range] plane in the present boundary which is obtained from the coordinate converting unit 192.

FIG. 10 is a diagram depicting an example of convex portion which is detected by the convex portion azimuth boundary detecting unit 193. The convex portion azimuth boundary detecting unit 193 detects points A and B depicted in FIG. 10 as the azimuth in which a convex portion appears in the stationary object boundary.

Specifically, the convex portion azimuth boundary detecting unit 193 calculates a difference between the range coordinates of each stationary object boundary in the azimuth axis direction of the stationary object boundary depicted in FIG. 10. Then, the convex portion azimuth boundary detecting unit 193 compares the difference between the range coordinates with a predetermined threshold value and detects an azimuth in which a convex portion appears in the stationary object boundary.

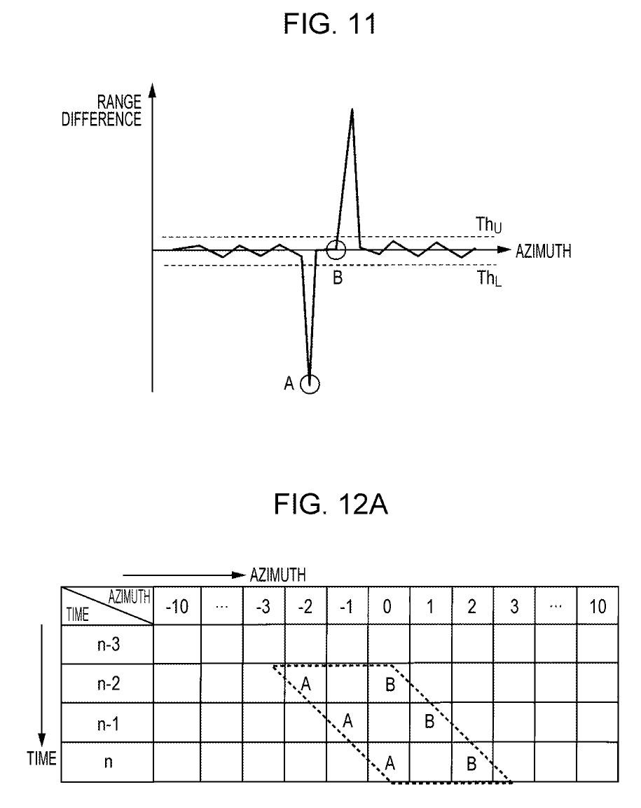

FIG. 11 is a diagram depicting an example of the detection processing in the convex portion azimuth boundary detecting unit 193. In FIG. 11, a difference between the range coordinates of each stationary object boundary is depicted in the azimuth axis direction of the stationary object boundary depicted in FIG. 10.

As depicted in FIG. 11, the convex portion azimuth boundary detecting unit 193 detects an azimuth in which the difference between the range components becomes a predetermined threshold value Th_{U} or more or Th_{L} or less. In the case of FIG. 11, the azimuth in which the difference becomes Th_{L} or less is the azimuth of the point A and the azimuth on the left (in a negative direction in the azimuth axis direction) of the azimuth in which the difference becomes Th_{U} or more is the azimuth of the point B. The convex portion azimuth boundary detecting unit 193 detects the azimuth of the point A and the azimuth of the point B as the azimuth of the convex portion and outputs the detected azimuth to the convex portion azimuth boundary variations calculating unit 194.

The convex portion azimuth boundary variations calculating unit 194 stores the azimuth of the convex portion which is obtained from the convex portion azimuth boundary detecting unit 193 in a convex portion azimuth table at each point in time. Then, the convex portion azimuth boundary variations calculating unit 194 determines a moving object included in the stationary object boundary based on the temporal variations in the convex portion in the convex portion azimuth table.

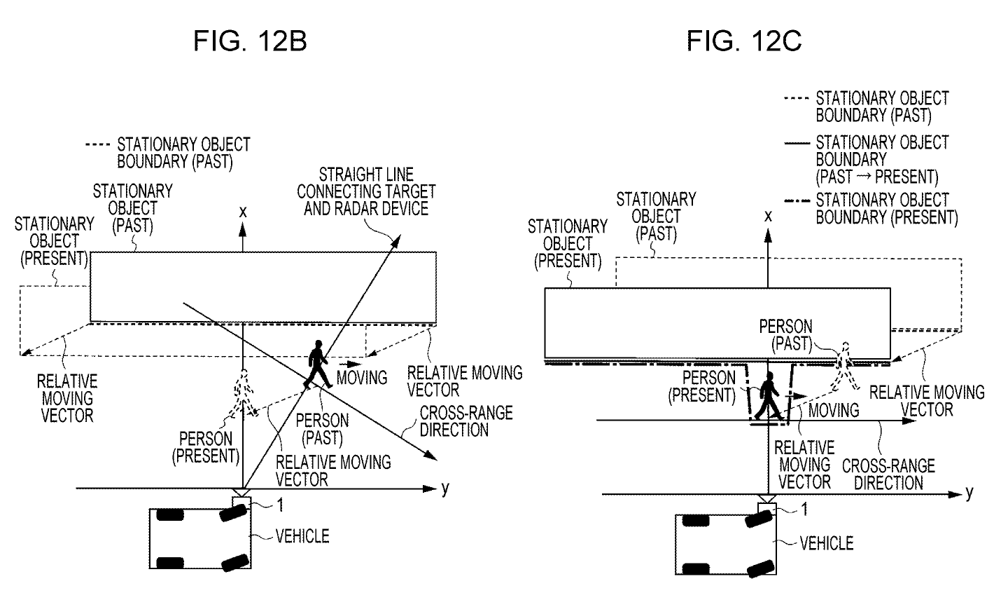

FIG. 12A is a diagram depicting an example of the convex portion azimuth table. Each row of FIG. 12A indicates each point in time with a frame number and each column indicates an azimuth. The convex portion azimuth boundary variations calculating unit 194 stores a mark (in FIG. 12A, A or B) indicating the convex portion in the convex portion azimuth table for each frame number.

When the target moves so as to cross the sensing range of the radar device 1, a region in which the moving direction of the target is the cross-range direction (hereinafter referred to as a cross-range region) appears. In that case, when the target enters the cross-range region, a convex portion appears in the stationary object boundary. Then, when the target moves in the cross-range region, the convex portion that has appeared moves in the azimuth direction.

Specifically, the convex portion azimuth boundary variations calculating unit 194 determines a point in time at which a mark has stored in the convex portion azimuth table as a point in time at which the target has entered the cross-range region. Then, the convex portion azimuth boundary variations calculating unit 194 determines the moving direction of the target corresponding to the convex portion by observing chronological changes in the convex portion.

In the case of the convex portion azimuth table depicted in FIG. 12A, a mark indicating a convex portion is not stored at an n−3 point in time, but marks A and B are stored at an n−2 point in time. Then, the marks A and B stored at the n−2 point in time move in the positive direction of the azimuth axis direction at an n−1 point in time and an n point in time.

In this case, the convex portion azimuth boundary variations calculating unit 194 determines that the target has entered the cross-range region at the n−2 point in time. Moreover, the convex portion azimuth boundary variations calculating unit 194 determines that the target is moving in the positive direction of the azimuth axis direction between the n−2 point in time and the n point in time.

The convex portion azimuth boundary variations calculating unit 194 outputs, to the output determining unit 195, the azimuth and the moving direction of the target that has entered the cross-range region. In so doing, the convex portion azimuth boundary variations calculating unit 194 may calculate the velocity of the target based on the movement of the target in the azimuth direction and output the velocity to the output determining unit 195.

The convex portion azimuth table may contain a convex portion caused by the shape of the stationary object. In this case, a mark of the convex portion caused by the shape of the stationary object is stored in the same azimuth direction at each point in time. Since the convex portion azimuth boundary variations calculating unit 194 observes chronological changes in the convex portion, the convex portion azimuth boundary variations calculating unit 194 does not determine the mark of the convex portion stored in the same azimuth direction as a target.

The output determining unit 195 generates cross-range moving target information by using the azimuth and the moving direction (and the velocity) of the target obtained from the convex portion azimuth boundary variations calculating unit 194 and the present stationary object boundary obtained from the coordinate converting unit 192.

Specifically, the output determining unit 195 determines a region corresponding to the azimuth of the target on the [azimuth, range] plane of the present stationary object boundary as the present position of the target and generates the present position of the target as the cross-range moving target information. Moreover, the output determining unit 195 may generate, as the cross-range moving target information, cross-range moving target information including the moving direction (and the velocity) of the target.

FIG. 12B is a diagram depicting an example of the stationary object boundary which the radar device 1 observed in the past. Incidentally, FIG. 12B depicts an example in which the target is a person. The person is moving in front of the stationary object, but the person is moving in the direction which is not the cross-range direction with reference to the radar device 1. Therefore, the person is not detected as a stationary object boundary. That is, the person is detected as a moving object.

Next, FIG. 12C is a diagram depicting an example of the stationary object boundary observed by the radar device 1 in the present. FIG. 12C depicts an example in which the target is a person. The moving direction of the person moving in front of the stationary object has changed to the direction in which the person is moving in the cross-range direction with reference to the radar device 1 because of a change in the positional relationship of the person and the radar device 1. As a result, the stationary object boundary detected by the radar device 1 includes the boundary of the person.

Here, the stationary object boundary obtained by converting the stationary object boundary detected in the past into the present coordinate system does not include the boundary of the person. Therefore, by comparing the past stationary object boundary converted into the present coordinate system with the present stationary object boundary, the radar device 1 can determine that the detected convex portion is the target (in FIG. 12C, the person) moving in the cross range direction.

Furthermore, the radar device 1 can detect the target moving in the cross-range direction while following the target by observing variations in the azimuth of the detected convex portion.

As described above, in the first embodiment, the stationary object Doppler region calculating unit 17 calculates the Doppler velocity of a stationary object in the sensing range of the radar device 1 by using the velocity of the radar device 1, and the stationary object boundary detecting unit 18 obtains a map indicating the reflection intensity of the echo signal in each azimuth, in each range, and at each Doppler velocity and detects a stationary object boundary which is set with reference to the radar device 1 from the reflection intensity corresponding to the Doppler velocity of the stationary object. Then, the stationary object boundary variations detecting unit 19 calculates a moving object included in the stationary object boundary based on temporal changes in the stationary object boundary. With this configuration, even when the Doppler velocity of a target moving in the cross-range direction, that is, moving in the stationary object Doppler region becomes equal to the Doppler velocity of a peripheral stationary object, it is possible to detect the target separately from the peripheral stationary object.

### Second Embodiment

In the first embodiment, an example in which, when the stationary object boundary detecting unit detects a stationary object boundary, the stationary object boundary detecting unit maps data on a region corresponding to a stationary object Doppler region on an [azimuth, range, Doppler] map onto an [azimuth, range] plane defined by the azimuth axis and the range axis has been described. In a second embodiment, an example in which the stationary object boundary detecting unit maps data on a region corresponding to a stationary object Doppler region on an [azimuth, range, Doppler] map onto an [azimuth, Doppler] plane defined by the azimuth axis and the Doppler axis will be described.

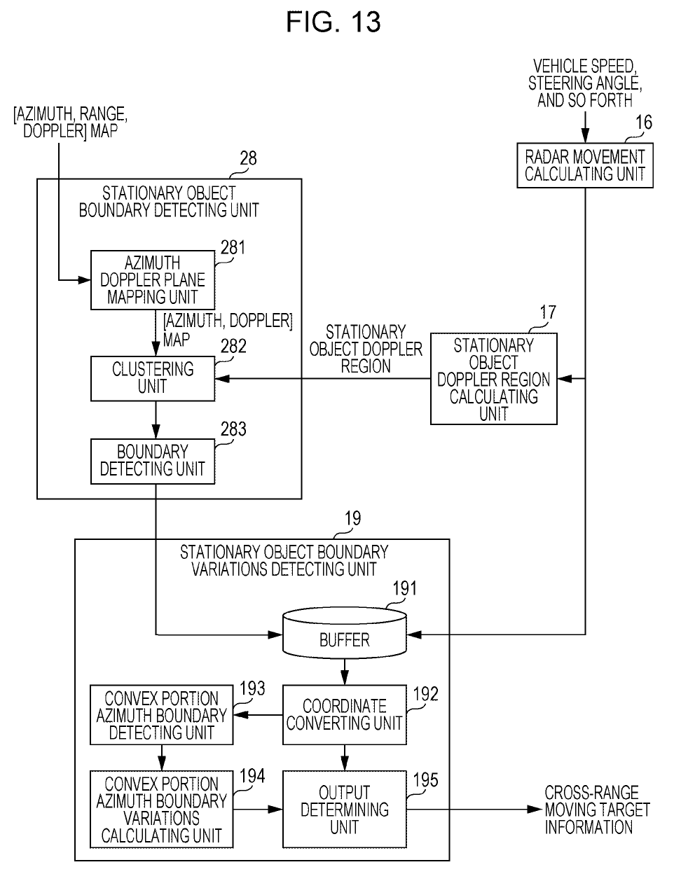

FIG. 13 is a block diagram depicting an example of the configuration of a stationary object boundary detecting unit 28 according to the second embodiment. In FIG. 13, component elements similar to the component, elements of FIGS. 2 and 6 are identified with the same reference numerals and the explanations thereof will be omitted.

A radar device according to the second embodiment has a configuration in which the stationary object boundary detecting unit 18 of the radar device 1 depicted in FIG. 2 is replaced with the stationary object boundary detecting unit 28 depicted in FIG. 13.

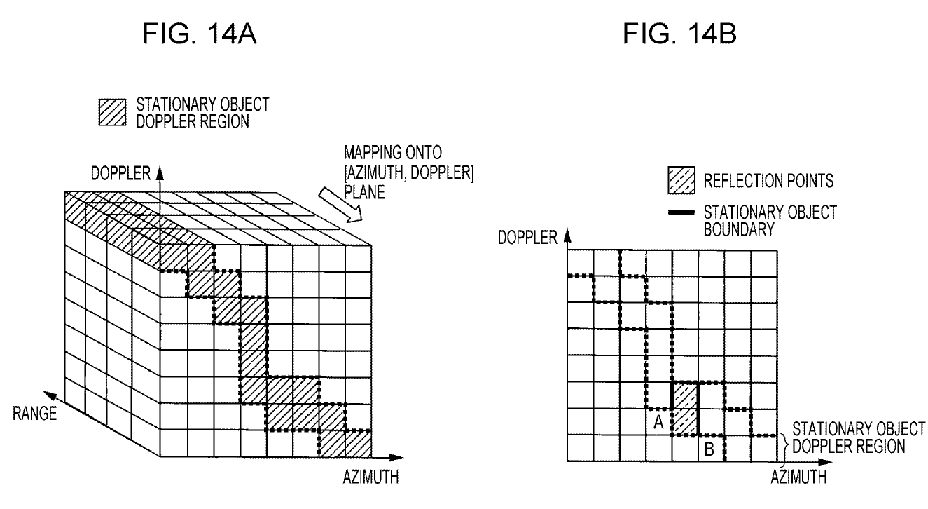

The stationary object boundary detecting unit 28 includes an azimuth Doppler plane mapping unit 281, a clustering unit 282, and a boundary detecting unit 283. Hereinafter, each component element will be described with reference to FIGS. 14A and 14B.

FIGS. 14A and 14B are diagrams depicting an example of a detection method of detecting a stationary object boundary in the second embodiment.

The azimuth Doppler plane mapping unit 281 maps data on the [azimuth, range, Doppler] map which is obtained from the direction-of-arrival estimating unit 14 (see FIG. 2) onto an [azimuth, Doppler] plane defined by the azimuth axis and the Doppler axis as depicted in FIG. 14A. In so doing, when the azimuth Doppler plane mapping unit 281 maps a plurality of pieces of data in one azimuth and one Doppler, the azimuth Doppler plane mapping unit 281 calculates one piece of data from the plurality of pieces of data by a method such as addition of spatial spectra, addition of power, or selection of a maximum value and maps the data onto the [azimuth, Doppler] plane. Moreover, when mapping the data onto the [azimuth, Doppler] plane, the azimuth Doppler plane mapping unit 281 holds each range component of the data before mapping in a state in which the range component is correlated with the data after mapping. Hereinafter, the data on the [azimuth, Doppler] plane after mapping is referred to as an [azimuth, Doppler] map.

The clustering unit 282 obtains the [azimuth, Doppler] map from the azimuth Doppler plane mapping unit 281 and obtains the stationary object Doppler region from the stationary object Doppler region calculating unit 17. Then, as depicted in FIG. 14B, the clustering unit 282 extracts data on a region corresponding to the stationary object. Doppler region on the [azimuth, Doppler] map, determines whether or not, of the extracted data, range components corresponding to reflection points are close to each other, and performs clustering of the reflection points whose range coordinates are close to each other. By performing clustering, it is possible to handle a plurality of reflection points collectively as one target.

The clustering unit 282 may determine that, if a difference between the range components of the adjacent reflection points is within a predetermined range in the stationary object. Doppler region, the range components are close to each other.

The clustering unit 282 outputs the [azimuth, Doppler] map subjected to the clustering processing to the boundary detecting unit 283.

The boundary detecting unit 283 detects azimuth components (point A and point B in FIG. 14B) of the coordinates at both ends of the reflection points on which clustering has been performed on the [azimuth, Doppler] map subjected to the clustering processing, which is obtained from the clustering unit 282. Then, the boundary detecting unit 283 generates data on an [azimuth, range] plane from the detected azimuth of the point A and the detected azimuth of the point B and the range component correlated with each azimuth. As a result, the boundary detecting unit 283 generates, as data on an [azimuth, range] plane, a stationary object boundary similar to the stationary object boundary depicted in FIG. 10.

The boundary detecting unit 283 outputs the stationary object boundary similar to the stationary object boundary depicted in FIG. 10 to the stationary object boundary variations detecting unit 19.

As described above, in the second embodiment, the stationary object boundary detecting unit 28 detects a stationary object boundary which is set with reference to the radar device 1 by obtaining a map indicating the reflection intensity of the echo signal in each azimuth, in each range, and at each Doppler velocity and mapping the reflection intensity of the map corresponding to the Doppler velocity of a stationary object onto an [azimuth, Doppler] plane defined by the azimuth axis and the Doppler axis.

By extracting IQ data in the stationary object. Doppler region on the [azimuth, Doppler] map, it is possible to limit an object to be detected to a peripheral stationary object and a moving body which moves in the cross-range direction, that is, whose Doppler velocity in the stationary object Doppler region is observed. That is, since a moving body having a Doppler velocity component in the range direction can be removed from objects to be detected, it is possible to reduce the possibility of an error in clustering which is performed by the clustering unit 282.

By detecting temporal variations in the azimuth boundary on which clustering has been performed as in this configuration, even when the Doppler velocity of a target moving in the cross-range direction becomes equal to the Doppler velocity of a peripheral stationary object, it is possible to detect the target separately from the peripheral stationary object.

### Third Embodiment

In a third embodiment, an example in which a target moving in the cross-range direction, that is, moving in the stationary object Doppler region and the target moving in a direction different from the cross-range direction are detected will be described.

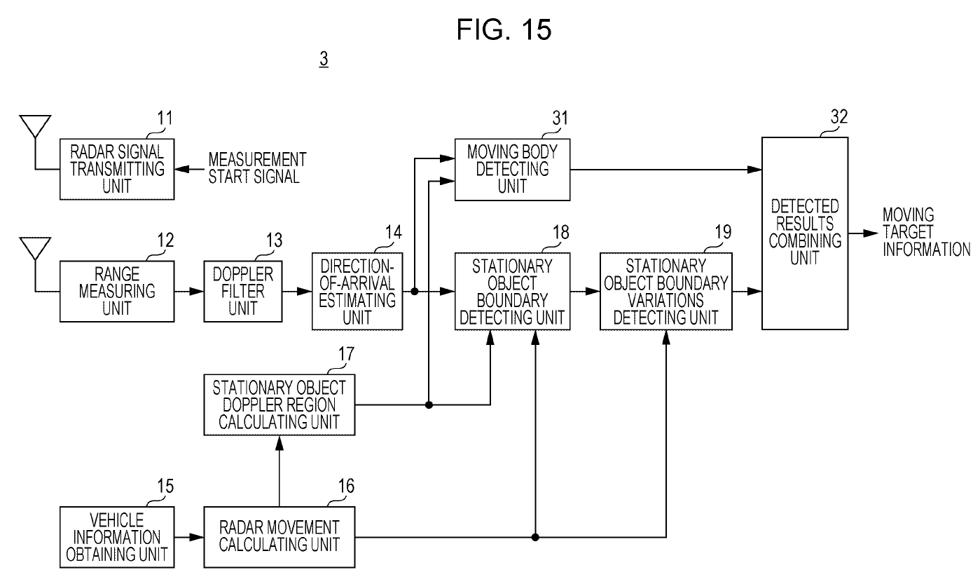

FIG. 15 is a block diagram depicting an example of the configuration of a radar device 3 according to the third embodiment. In FIG. 15, component elements similar to the component elements of FIG. 2 are identified with the same reference numerals and the explanations thereof will be omitted.

The radar device 3 according to the third embodiment has a configuration in which a moving body detecting unit 31 and a detected results combining unit 32 are added to the radar device 1 depicted in FIG. 2.

The moving body detecting unit 31 maps data on the [azimuth, range, Doppler] map which is obtained from the direction-of-arrival estimating unit 14 onto an [azimuth, Doppler] plane defined by the azimuth axis and the Doppler axis.

In so doing, when the moving body detecting unit 31 maps a plurality of pieces of data in one azimuth and one Doppler, the moving body detecting unit 31 calculates one piece of data from the plurality of pieces of data by a method such as addition of spatial spectra, addition of power, or selection of a maximum value and maps the data onto the [azimuth, Doppler] plane.

Moreover, when mapping the data onto the [azimuth, Doppler] plane, the moving body detecting unit 31 holds each range component of the data before mapping in a state in which the range component is correlated with the data after mapping. Hereinafter, the data on the [azimuth, Doppler] plane after mapping is referred to as an [azimuth, Doppler] map.

The moving body detecting unit 31 performs clustering of reflection points whose range components are close to each other on the [azimuth, Doppler] map. Moreover, the moving body detecting unit 31 obtains the stationary object Doppler region from the stationary object Doppler region calculating unit 17. Then, the moving body detecting unit 31 detects a reflection point existing in a region outside the stationary object Doppler region on the [azimuth, Doppler] plane on which clustering has been performed.

As described above, the reflection point existing in the stationary object Doppler region is a point reflected from the stationary object or a point reflected from the target which moves in the cross-range direction, that is, whose Doppler velocity in the stationary object Doppler region is observed. By detecting a reflection point existing in a region outside the stationary object Doppler region, the moving body detecting unit 31 can detect the target moving in a direction different from the cross-range direction.

The moving body detecting unit 31 outputs information indicating the position of the detected reflection point of the target to the detected results combining unit 32.

The detected results combining unit 32 obtains, from the moving body detecting unit 31, the information indicating the position of the target moving in a direction different from the cross-range direction. The detected results combining unit 32 obtains, from the stationary object boundary variations detecting unit 19, the cross-range moving target information indicating the position of the target which moves in the cross-range direction, that is, whose Doppler velocity in the stationary object Doppler region is observed. Then, the detected results combining unit 32 combines the position of the target moving in a direction different from the cross-range direction and the position of the target moving in the cross-range direction.

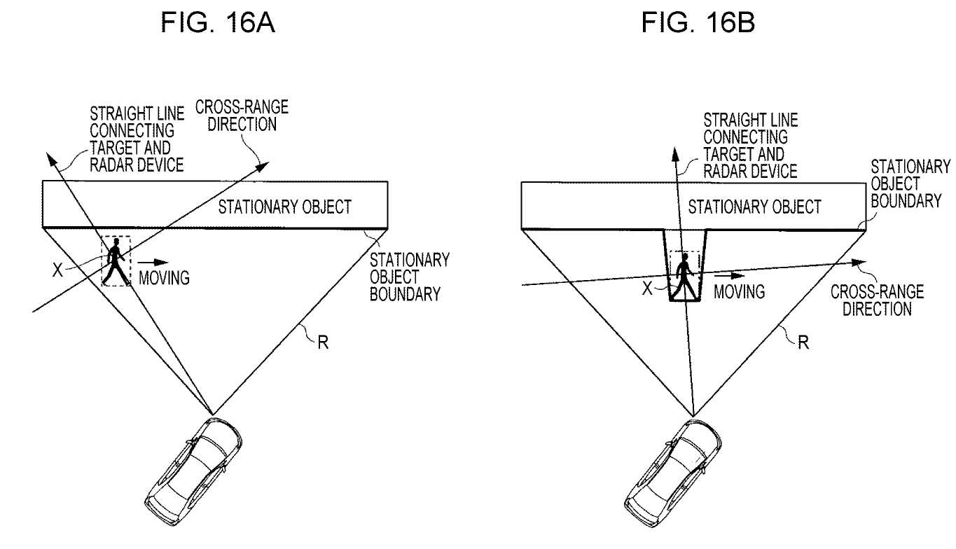

FIGS. 16A and 16B are diagrams depicting the combining processing in the detected results combining unit 32. FIG. 16A depicts a target X moving in a direction different from the cross-range direction, and FIG. 16B depicts the target X moving in the cross-range direction. The detected results combining unit 32 combines the position of the target. X depicted in FIG. 16A and the position of the target X depicted in FIG. 16B, and outputs the result as moving target information indicating the position of the target X in the sensing range of the radar device 3.

As described above, the radar device 3 of the third embodiment includes the moving body detecting unit 31 that detects a target moving in a direction different from the cross-range direction and the detected results combining unit 32 that combines the position of the target moving in a direction different from the cross-range direction and the position of the target moving in the cross-range direction. With this configuration, it is possible to detect the target moving in the sensing range of the radar device in a seamless manner and follow the target in the sensing range more effectively.

In the third embodiment, an example in which the radar device 3 includes the stationary object boundary detecting unit 18 depicted in FIG. 2 has been described, but the present disclosure is not limited thereto. The stationary object boundary detecting unit 18 may be replaced with the stationary object boundary detecting unit 28 depicted in FIG. 13.

In each embodiment described above, an example in which mapping is performed onto a two-dimensional plane by using a three-dimensional [azimuth, range, Doppler] map and a stationary object boundary is detected has been described, but the present disclosure is not limited thereto. Data which is used when a stationary object boundary is detected is not limited to a three-dimensional map as long as the data is data indicating the reflection intensity of the echo signal correlated with each azimuth, each range, and each Doppler velocity. In addition, the stationary object boundary detecting unit calculates a stationary object boundary by using data on the reflection intensity corresponding to the Doppler velocity of a stationary object included in the data. In so doing, the stationary object boundary detecting unit may calculate a stationary object boundary based on the reflection intensity without performing mapping onto a two-dimensional plane.

Although various embodiments have been described with reference to the drawings, it goes without saying that the present disclosure is not limited to these examples. A person skilled in the art could easily conceive of various changed or modified examples within the scope of claims, and it, should be understood that these changed or modified examples would fall within the technical scope of the present disclosure. Moreover, the component elements in the above-described embodiments may be arbitrarily combined without departing from the spirit of the disclosure.

The present disclosure can be realized by software, hardware, or software in cooperation with hardware.

Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a field programmable gate array (FPGA) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

The present disclosure may be used for a radar device which is mounted on a vehicle.

What is claimed is:

1. A radar device comprising:
a transmitter including a first antenna which, in operation, transmits a radar signal;
a receiver including a second antenna which, in operation, receives an echo signal that is the radar signal reflected from an object;
a stationary object boundary detector which, in operation, detects a boundary of a first region in which a stationary object exists by using the echo signal; and
a stationary object boundary variations detector which, in operation, detects a second region in which temporal changes are observed in the boundary of the first region and detects a third region that is the region moving in a cross-range direction, as a first moving object.

2. The radar device according to claim 1, comprising:
a radar movement calculator which, in operation, calculates a velocity of the radar device;
a stationary object Doppler region calculator which, in operation, calculates a first Doppler velocity of a stationary object in a sensing range defined by an azimuth and a range of the second antenna by using the velocity of the radar device; and
a received signal analyzer which, in operation, analyzes the echo signal and generates IQ data indicating a reflection intensity of the echo signal correlated with an azimuth, a range, and a second Doppler velocity indicated by the echo signal received by the second antenna, wherein
the stationary object boundary detector, in operation, detects the boundary of the first region by using a reflection intensity corresponding to the first Doppler velocity of the stationary object in the IQ data.

3. The radar device according to claim 2, wherein
the IQ data is a three-dimensional map defined by an axis indicating the azimuth, an axis indicating the range, and an axis indicating the second Doppler velocity, and
the stationary object boundary detector, in operation, maps the reflection intensity corresponding to the first Doppler velocity of the stationary object onto a two-dimensional plane defined by the axis indicating the range and the axis indicating the azimuth from the three-dimensional map and detects a boundary indicated by a reflection intensity on the two-dimensional plane as the boundary of the first region.

4. The radar device according to claim 3, wherein
the stationary object boundary detector, in operation, performs smoothing processing on a boundary of a region in which a present stationary object exists and a boundary obtained by converting a boundary of a region in which a past stationary object exists into a present coordinate system and outputs, to the stationary object boundary variations detector, a boundary obtained by the smoothing processing as the boundary of the first region.

5. The radar device according to claim 2, wherein
the IQ data is a three-dimensional map defined by an axis indicating the azimuth, an axis indicating the range, and an axis indicating the second Doppler velocity, and
the stationary object boundary detector, in operation, maps the reflection intensity corresponding to the first Doppler velocity of the stationary object onto a two-dimensional plane defined by the axis indicating the azimuth and the axis indicating the second Doppler velocity from the three-dimensional map and detects a boundary indicated by a reflection intensity on the two-dimensional plane as the boundary of the first region.

6. The radar device according to claim 1, wherein
when a convex portion included in the boundary of the first region moves with time, the stationary object boundary variations detector, in operation, detects the convex portion as the first object.

7. The radar device according to claim 2, comprising:
a moving body detector which, in operation, detects a second moving object in a direction different from the cross-range direction by using a reflection intensity corresponding to the second Doppler velocity different from the first Doppler velocity of the stationary object in the IQ data; and
a detected results combiner which, in operation, combines positional information on the first moving object and positional information on the second moving object and outputs a result.

8. A detection method comprising:
transmitting a radar signal;
receiving an echo signal that is the radar signal reflected from an object;
detecting a boundary of a first region in which a stationary object exists by using the echo signal;
detecting a second region in which temporal changes are observed in the boundary of the first region; and
detecting a third region that is the second region moving in a cross-range direction, as a first moving object.
